(19) United States
(12) Patent Application Publication
(10) Pub. No.: US 2011/0062871 A1
(43) Pub. Date: Mar. 17, 2011

(54) AC-LED PROTECTION CIRCUIT

(75) Inventors: YUE-ZHI CHEN, Tu-Cheng (TW); CHIA-CHEN CHANG, Tu-Cheng (TW)

(73) Assignee: ADVANCED OPTOELECTRONIC TECHNOLOGY, INC., Hsinchu Hsien (TW)

(21) Appl. No.: 12/875,139

(22) Filed: Sep. 3, 2010

(30) Foreign Application Priority Data
Sep. 11, 2009 (CN) 200910173731.5

(51) Int. Cl. H05B 37/00

(52) U.S. Cl. 315/121

(57) ABSTRACT

An AC-LED protection circuit comprises an AC-LED with a first terminal and a second terminal, and a circuit protection unit electrically connects with the first and second terminals of the AC-LED. When a voltage between two terminals of the circuit protection unit exceeds a voltage threshold, the circuit protection unit substantially forms a short circuit. Also, when a current through the circuit protection units exceeds a current threshold, the circuit protection unit forms a substantial open circuit.

### BACKGROUND

1. Technical Field

The disclosure relates to LED illumination, and particularly to an AC-LED protection circuit.

2. Description of the Related Art

AC-LEDs differ from DC-LEDs in their ability to be applied directly in a AC voltage system and illuminate under both positive and negative voltage. Moreover, unlike DC-LEDs AC-LEDs require no AC-to-DC converter and can be applied directly from the mains, increasing convenience, reducing costs, and extending the scope of application.

However, no circuit protection is currently available for the AC-LED. When the voltage or current of AC-LED device suddenly increases over acceptable limits, damage to the AC-LED can result. What is needed therefore, is an AC-LED protection circuit overcoming the described limitations.

### BRIEF DESCRIPTION OF THE DRAWINGS

Many aspects of the disclosure can be better understood with reference to the following drawings. The components in the drawings are not necessarily drawn to scale, the emphasis instead placed upon clearly illustrating the principles of the present illumination device. Moreover, in the drawing, like reference numerals designate corresponding parts throughout the several views.

FIG. 1 is an internal circuit diagram of an AC-LED.

FIG. 2 is a circuit diagram of an AC-LED protection circuit in accordance with a first embodiment.

FIG. 3 is a circuit diagram of an AC-LED protection circuit in accordance with a second embodiment.

FIG. 4 is a circuit diagram of an AC-LED protection circuit in accordance with a third embodiment.

FIG. 5 is a circuit diagram of an AC-LED protection circuit in accordance with a fourth embodiment.

FIG. 6 is a circuit diagram of an AC-LED protection circuit in accordance with a fifth embodiment.

FIG. 7 is a circuit diagram of an AC-LED protection circuit in accordance with a sixth embodiment.

FIG. 8 is a circuit diagram of an AC-LED protection circuit in accordance with a seventh embodiment.

FIG. 9 is a circuit diagram of the AC-LED protection circuit in accordance with an eighth embodiment.

FIG. 10 is a schematic view of the AC-LED protection circuit and the AC-LED integrated as an illumination module which is driven by an alternating current source.

FIG. 11 is a schematic view of the AC-LED protection circuit and the AC-LED which are encapsulated into a LED chip.

### DETAILED DESCRIPTION

Embodiments of the AC-LED protection circuit are described in detail here with reference to the drawings.

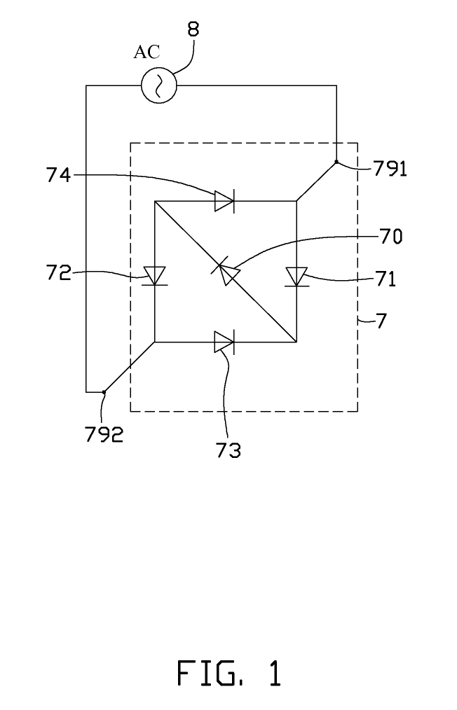

Referring to FIG. 1, an AC-LED 7 includes a first terminal 791, a second terminal 792, and five DC-LEDs 70-74. When the AC-LED 7 electrically connects to an alternating current source 8, the voltage polarity of the first terminal 791 and the second terminal 792 vary over time. When the voltage of the first terminal 791 is positive and the voltage of the second terminal 792 is negative, the DC-LEDs 70, 71, and 72 are turned on, receive current which is output at the second terminal 792, and AC-LED 7 emits light. Alternatively, when the voltage of the first terminal 791 is negative and the voltage of the second terminal 792 is positive, the DC-LEDs 70, 73, and 74 are turned on as current flows through the DC-LEDs 70, 73, and 74, and is output at the first terminal 791. AC-LED 7 thus emits light when receiving current, irrespective of positivity of voltage to the first terminal 791 and the second terminal 792.

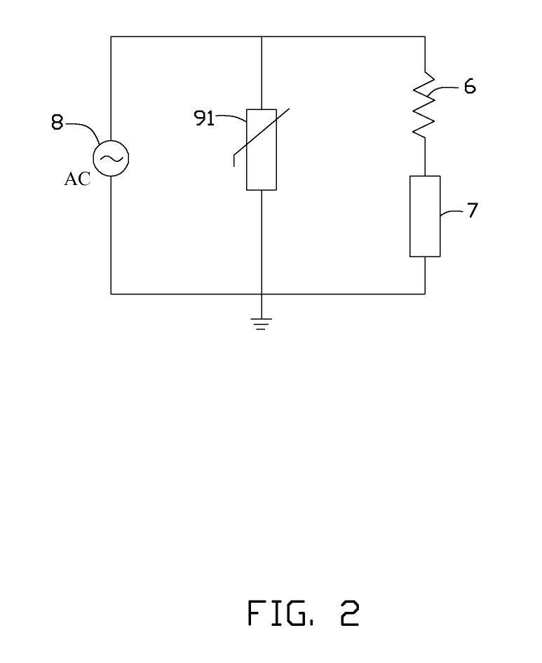

Referring to FIG. 2, an AC-LED protection circuit in accordance with a first embodiment includes a voltage overload protection unit, such as a varistor 91.

The varistor 91, an AC-LED 7, an alternating current source 8, and a resistor 6 compose a first sample circuit. The varistor 91, the AC-LED 7, the alternating current source 8, and the resistor 6 respectively have a first terminal and a second terminal. The first terminal of the varistor 91 electrically connects to the first terminal of the resistor 6 and the first terminal of the alternating current source 8. The second terminal of the varistor 91, the second terminal 792 of the AC-LED 7 and the second terminal of the alternating current source 8 electrically connect to ground. The second terminal of the resistor 6 electrically connects to the first terminal 791 of the AC-LED 7. The resistor 6, a current limiting resistor, limits current through the AC-LED 7.

As alternating current source 8 breaks down, a surge occurs at the switch, static electricity or electric shock, cause voltage of the circuit to spike, the voltage difference between the first terminal and the second terminal of the varistor 91 increases; and when the voltage difference between the two terminals of the varistor 91 exceeds a voltage threshold, the equivalent circuit of the varistor 91 generates a substantial short circuit. In other words, when the alternating current source 8 breakdown, most of the current flows through the short circuit of the varistor 91, and the current is conducted to ground. Therefore, the circuit protection unit of the AC-LED in accordance with the first embodiment can reduce damage to the AC-LED 7, when current is provided by suddenly increasing the voltage at the fault of the alternating current source 8.

In the first embodiment, the varistor 91 can be another circuit protection unit having voltage overload protecting characteristic.

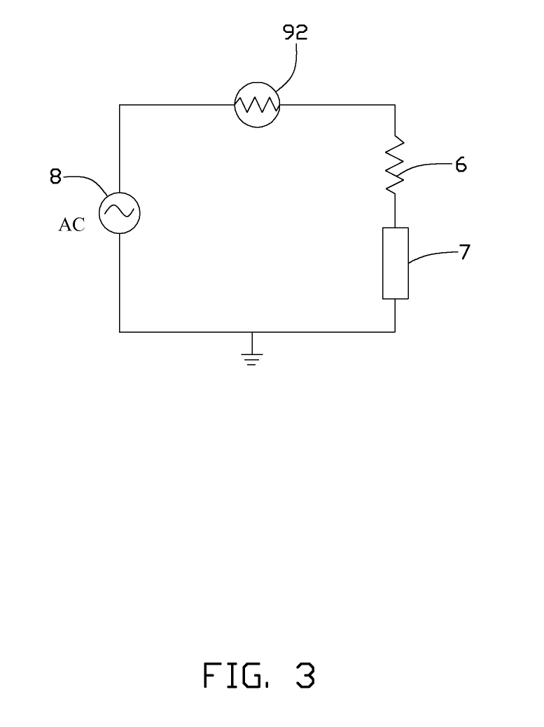

Referring to FIG. 3, an AC-LED protection circuit in accordance with a second embodiment includes a current protection unit, such as a thermistor 92.

The second circuit includes a thermistor 92, an AC-LED 7, and a resistor 6. The thermistor 92, the AC-LED 7, the alternating current source 8 and the resistor 6 respectively have a first terminal and a second terminal. The first terminal of the thermistor 92 electrically connects to the first terminal of the alternating current source 8 and the second terminal of thermistor 92 electrically connects to the first terminal 791 of the AC-LED 7 via the resistor 6. The second terminal 792 of the AC-LED 7 and the second terminal of the alternating current source 8 connect to ground. In other words, the thermistor 92, the AC-LED 7, the alternating current source 8 and the resistor 6 form the second sample circuits by series connection. The thermistor 92 has a device characteristic with an impedance positive relative to temperature. In normal operating state of the second sample circuit, the resistance of the thermistor 92 is very small. Thus, the resistance of the thermistor 92 does not affect the operation of other elements of the second sample circuit. However, when the second sample circuit breaks down, the breakdown causes current of the second sample circuit to increase rapidly. When the current abnormally increases, the circuit element of the second sample exceeds heated. When the temperature rapidly rises, the resistance of the thermistor 92 rapidly increases, restraining the increase rate of the current in the second sample circuit. When a current through the thermistor 92 exceeds a current threshold, the equivalent circuit of thermistor 92 forms a substantial open-loop. That can isolate damage to the AC-LED 7 induced by an overcurrent. Thus, the circuit protection of AC-LED in accordance with the second embodiment can effectively restrain the current and protect the AC-LED 7. More preferably, when the second sample circuit and a current of the second sample circuit return to the normal status, the resistance of the thermistor 92 actively returns to the low resistance. Thus, after the fault of the second sample circuit has been solved, the thermistor 92 can be repeatedly utilized.

The thermistor 92 can be PTC fuse (positive temperature coefficient fuse), PTTC resistor (polymer positive temperature coefficient resistor) or other current protection units.

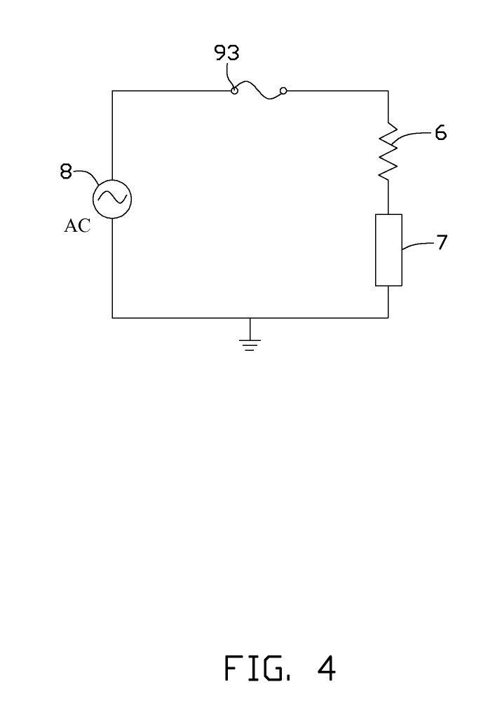

Referring to FIG. 4, an AC-LED protection circuit in accordance with a third embodiment includes a current protection unit, such as a fuse 93.

The fuse 93, the AC-LED 7, the alternating current source 8 and the resistor 6 form a third sample circuit. The fuse 93, the AC-LED 7, the alternating current source 8 and the resistor 6 respectively have a first terminal and a second terminal. The first terminal of the fuse 93 electrically connects to the first terminal of the alternating current source 8 and the second terminal of fuse 93 electrically connects to the first terminal 791 of the AC-LED 7 via the resistor 6. The second terminal 792 of the AC-LED 7 and the second terminal of the alternating current source 8 connect to ground. In other words, the fuse 93, the AC-LED 7, the alternating current source 8 and the resistor 6 form the third sample circuits by series connection.

In normal operating state of the third sample circuit, the fuse 93 is in the conduct status. When the third sample circuit breaking down elevates current over the threshold, the fuse 93 burns and forms a substantial open-loop that can isolate damage to the AC-LED 7. Thus, the protection circuit of the AC-LED 7 in accordance with the third embodiment can effectively protect the AC-LED 7 to avoid the damage of the AC-LED 7 by the fault of the third sample circuit.

The difference between the third embodiment and the second embodiment is that when the fuse 93 burns, a new fuse 93 is required to reconnect the third sample circuit.

In the third embodiment, the fuse 93 can be another circuit protection unit providing current overload protection.

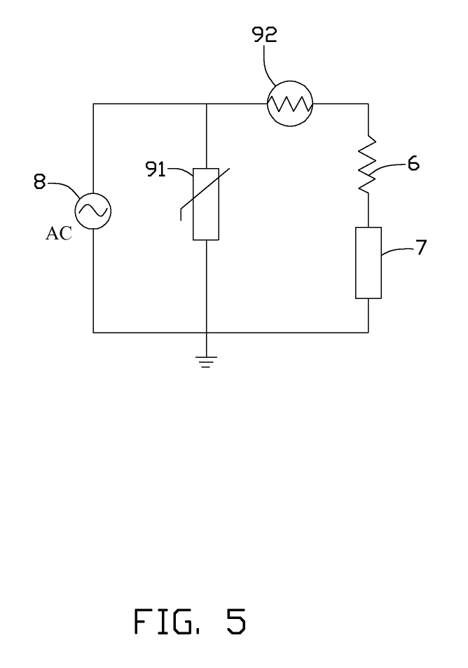

Referring to FIG. 5, an AC-LED protection circuit in accordance with a fourth embodiment includes a voltage protection unit, such as a varistor 91 and a current protection unit, such as a thermistor 92.

The varistor 91, the thermistor 92, the AC-LED 7, the alternating current source 8 and the resistor 6 form the fourth sample circuit. The varistor 91, the thermistor 92, the AC-LED 7, the alternating current source 8 and the resistor 6 respectively have a first terminal and a second terminal. The first terminal of the varistor 91 electrically connects to the first terminal of the thermistor 92 and the first terminal of the alternating current source 8. The second terminal of the varistor 91, the second terminal 792 of the AC-LED 7 and the second terminal of the alternating current source 8 connect to ground. The second terminal of the thermistor 92 connects to the first terminal of the resistor 6. The second terminal of the resistor 6 connects to the first terminal 791 of the AC-LED 7.

Thus, the alternating current source 8 breaking down, effect of surge of the switch, static electricity or electric shock, causes the voltage of the circuit to suddenly increase. At this time, the voltage difference between the first terminal and the second terminal of the varistor 91 rapidly increases; while the voltage difference of the two terminals of the varistor 91 exceeds a voltage threshold, the equivalent circuit of the varistor 91 substantially forms a short circuit. The current is conducted to ground. In other words, when the alternating current source 8 breaks down, most of the current flows through the short circuit of the varistor 91 and is conducted to ground, reducing damage to the AC-LED 7.

The thermistor 92 has a device characteristic with an impedance positive relative to temperature. In normal operating state of the fourth sample circuit, the resistance of the thermistor 92 is very small and can be ignored, with no effect on the operation of other elements of the fourth sample circuit. However, when the fourth sample circuit breaks down, current of the fourth sample circuits increases rapidly. After the current abnormally increases, the circuit element of the fourth sample overheats. Therefore, after the temperature rapidly rises, the resistance of the thermistor 92 rapidly increases, and can restrain the increase rate of the current.

When a current through the thermistor 92 exceeds a current threshold, the equivalent circuit of thermistor 92 forms a substantial open-loop. That can isolate damage to the AC-LED 7 induced by an overcurrent. Thus, the AC-LED protection circuit in accordance with the fourth embodiment can effectively restrain the current and protect the AC-LED 7. More preferably, when the fourth sample circuit and a current of the fourth sample circuit return to the normal status, the resistance of the thermistor 92 actively returns to the low resistance. Thus, after the fault of the fourth sample circuit has been solved, the thermistor 92 can be repeatedly utilized.

In the fourth embodiment, the varistor 91 can be another circuit protection unit providing voltage overload protection. The thermistor 92 can be PTC fuse (positive temperature coefficient fuse), PTTC resistor (polymer positive temperature coefficient resistor) or other current protection units.

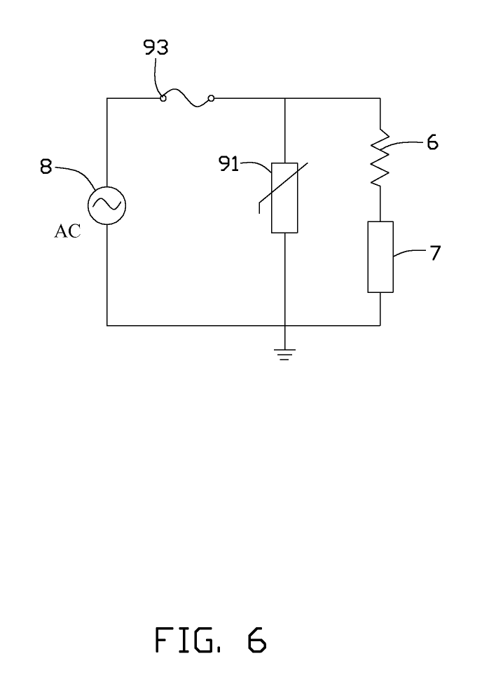

Referring to FIG. 6, an AC-LED protection circuit in accordance with a fifth embodiment includes a voltage protection unit, such as a varistor 91 and a current protection unit, such as a fuse 93.

The varistor 91, the fuse 93, the AC-LED 7, the alternating current source 8 and the resistor 6 form the fifth sample circuit. The varistor 91, the fuse 93, the AC-LED 7, the alternating current source 8 and the resistor 6 respectively have a first terminal and a second terminal. The first terminal of the varistor 91 electrically connects to the second terminal of the fuse 93 and the first terminal of the resistor 6. The second terminal of the varistor 91, the second terminal 792 of the AC-LED 7 and the second terminal of the alternating current source 8 connect to ground. The first terminal of the fuse 93 connects the first terminal of the alternating current source 8. The second terminal of the resistor 6 connects the first terminal 791 of the AC-LED 7.

Thus, the alternating current source 8 breaking down, effect of surge of the switch, static electricity or electric shock, causes the voltage of the circuit to suddenly increase. At this time, the voltage difference between the first terminal and the second terminal of the varistor 91 increases; while the voltage difference of the two terminals of the varistor 91 exceeds a voltage threshold, the equivalent circuit of the varistor 91 generates a substantial short circuit. The current is conducted to ground. In other words, when the alternating current source 8 breaks down, most of the current flows through the short circuit of the varistor 91, and the current is conducted to ground, reducing damage to the AC-LED 7, due to current provided by suddenly increasing the voltage at the fault of the alternating current source 8.

In normal operating state of the fifth sample circuit, the fuse 93 is in the conduct status. When the fifth sample circuit breaking down elevates current over the threshold, the fuse 93 burns and forms a substantial open-loop. That can isolate damage to the AC-LED 7 induced by an overcurrent. Thus, the protection circuit of the AC-LED 7 in accordance with the fifth embodiment can effectively protect the AC-LED 7 to avoid the damage of the AC-LED 7 by the fault of the fifth sample circuit.

The difference between the fifth embodiment and the fourth embodiment is that when the fuse 93 burns, user must replace a new fuse 93 in order to reconnect the fifth sample circuit.

In the fifth embodiment, the varistor 91 can be another circuit protection unit providing voltage overload protection. The fuse 93 can be another circuit protection unit providing current overload protection.

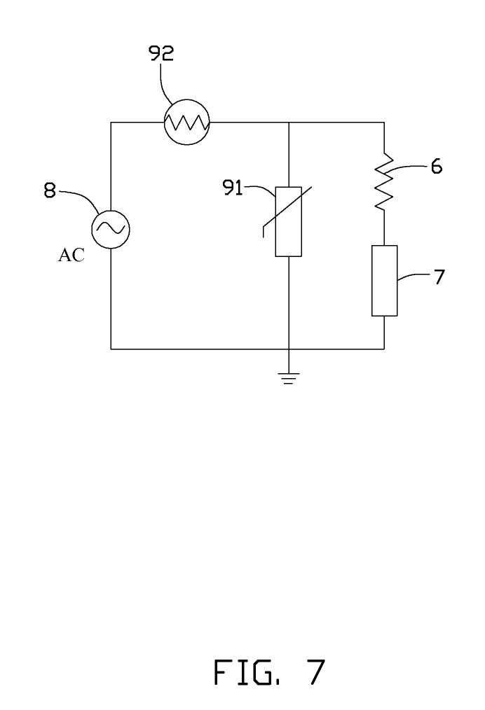

Referring to FIG. 7, an AC-LED protection circuit in accordance with a sixth embodiment includes a voltage protection unit, such as a varistor 91 and a current protection unit, such as a thermistor 92.

The varistor 91, the thermistor 92, the AC-LED 7, the alternating current source 8 and the resistor 6 form the sixth sample circuits. The varistor 91, the thermistor 92, the AC-LED 7, the alternating current source 8 and the resistor 6 respectively have a first terminal and a second terminal. The first terminal of the varistor 91 electrically connects to the second terminal of the thermistor 92 and the first terminal of resistor 6. The second terminal of the varistor 91, the second terminal 792 of the AC-LED 7 and the second terminal of the alternating current source 8 are connected to ground. The first terminal of the thermistor 92 connects to the first terminal of alternating current source 8. The second terminal of the resistor 6 connects to the first terminal 791 of the AC-LED 7.

Thus, breakdown of the alternating current source 8 due to effect of surge of the switch, static electricity or electric shock, causes the voltage of the circuit to suddenly increase. At this time, the voltage difference between the first terminal and the second terminal of the varistor 91 increases; while the voltage difference of the two terminals of the varistor 91 exceeds a voltage threshold, the equivalent circuit of the varistor 91 generates a substantial short circuit. The current is conducted to ground. In other words, after the alternating current source 8 breaks down, most of the current flows through the short circuit of the varistor 91, and the current is conducted to ground, reducing damage to the AC-LED 7.

The thermistor 92 has a device characteristic with an impedance positive relative to temperature. In normal operating state of the sixth sample circuit, the resistance of the thermistor 92 is very small and can be ignored, with no effect the operation of other elements of the sixth sample circuit. However, after the sixth sample circuit breaks down, the breakdown causes current of the sixth sample circuits increase rapidly. When the current abnormally increases, the circuit element of the sixth sample exceeds heating. Therefore, after the temperature rapidly rises, the resistance of the thermistor 92 rapidly increases. Therefore, that can restrain the increase rate of the current. When a current through the thermistor 92 exceeds a current threshold, the equivalent circuit of thermistor 92 forms a substantial open-loop. That can isolate damage to the AC-LED 7 induced by an overcurrent. Thus, the protection circuit of the AC-LED in accordance with a sixth embodiment can effectively restrain the current and protect the AC-LED. More preferably, when the sixth sample circuit and a current of the sixth sample circuit return to the normal status, the resistance of the thermistor 92 actively returns to the low resistance. Thus, the fault of the sixth sample circuit has been solved, the thermistor 92 can be repeatedly utilized.

In the sixth embodiment, the varistor 91 can be another circuit protection unit providing voltage overload protection. The thermistor 92 can be PTC fuse (positive temperature coefficient fuse), PTTC resistor (polymer positive temperature coefficient resistor) or other current protection units.

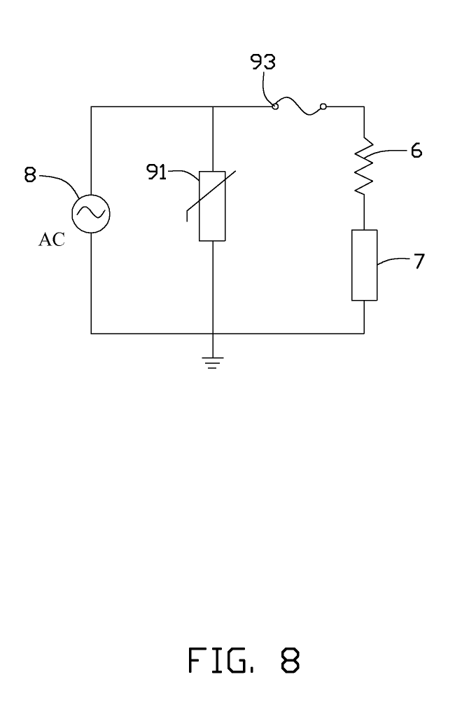

Referring to FIG. 8, the protection circuit of AC-LED 7 in accordance with the seventh embodiment includes a voltage protection unit, such as a varistor 91 and a current protection unit, such as a fuse 93.

The varistor 91, the fuse 93, the AC-LED 7, the alternating current source 8 and the resistor 6 form the seventh sample circuit. The varistor 91, the fuse 93, the AC-LED 7, the alternating current source 8 and the resistor 6 respectively have a first terminal and a second terminal. The first terminal of the varistor 91 electrically connects to the first terminal of the fuse 93 and the first terminal of the alternating current source 8. The second terminal of the varistor 91, the second terminal 792 of the AC-LED 7 and the second terminal of the alternating current source 8 connect to ground. The second terminal of the fuse 93 connects to the first terminal of the resistor 6. The second terminal of the resistor 6 connects to the first terminal 791 of the AC-LED 7.

Thus, breakdown of the alternating current source 8 due to effect of surge of the switch, static electricity or electric shock, causes the voltage of the seventh sample circuit to suddenly increase. At this time, the voltage difference between the first terminal and the second terminal of the varistor 91 increases; while the voltage difference of the two terminals of the varistor 91 exceeds a voltage threshold, the equivalent circuit of the varistor 91 generates a substantial short circuit. The current is conducted to ground. In other words, after the alternating current source 8 breaks down, most of the current flows through the short circuit of the varistor 91, and the current is conducted to ground, reducing damage to the AC-LED 7, due to current provided by suddenly increasing the voltage at the fault of the alternating current source 8.

In normal operating state of the seventh sample circuit, the fuse 93 is in the conduct status. When the seventh sample circuit breaking down elevates current over the threshold, the fuse 93 burns and forms a substantial open loop, isolating damage to the AC-LED 7.

The difference between the seventh embodiment and the fourth embodiment is that when the fuse 93 burns, a new fuse 93 is required to reconnect the third sample circuit.

In the seventh embodiment, the varistor 91 can be another circuit protection unit providing voltage overload protection. The fuse 93 can be another circuit protection unit providing current overload protection.

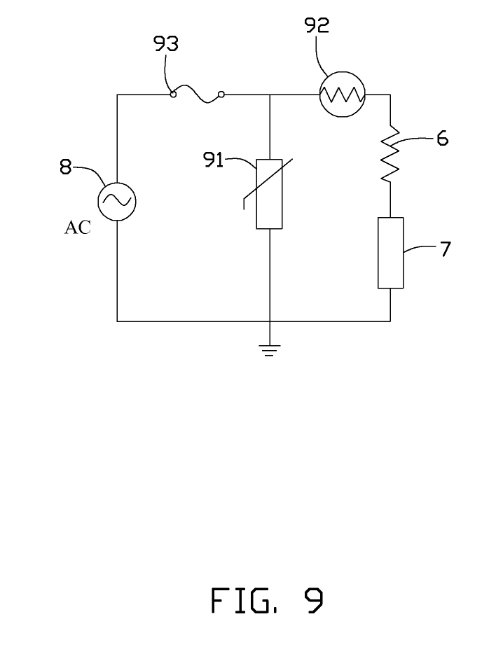

Referring to FIG. 9, an AC-LED protection circuit in accordance with an eighth embodiment includes a voltage protection unit, such as a varistor 91 and a current protection unit, such as a fuse 93 and a thermistor 92.

The varistor 91, the thermistor 92, the fuse 93, the AC-LED 7, the alternating current source 8 and the resistor 6 form the eighth sample circuit. The varistor 91, the thermistor 92, the fuse 93, the AC-LED 7, the alternating current source 8 and the resistor 6 respectively have a first terminal and a second terminal. The first terminal of the varistor 91 electrically connects to the second terminal of the fuse 93 and the first terminal of the alternating current source 8 via the fuse 93. The second terminal of the thermistor 92 connects to the first terminal of the resistor 6. The second terminal of the varistor 91, the second terminal 792 of the AC-LED 7 and the second terminal of the alternating current source 8 are connected to ground. The second terminal of the resistor 6 connects to the first terminal 791 of the AC-LED 7.

Thus, breakdown of the alternating current source 8 due to effect of surge of the switch, static electricity or electric shock, causes the voltage of the seventh sample circuit suddenly increases. At this time, the voltage difference between the first terminal and the second terminal of the varistor 91 increases; while the voltage difference of the two terminals of the varistor 91 exceeds a voltage threshold, the equivalent circuit of the varistor 91 generates a substantial short circuit. The current is conducted to ground. In other words, after the alternating current source 8 breaks down, most of the current flows through the short circuit of the varistor 91, and the current is conducted to ground, reducing damage to the AC-LED 7, due to current provided by suddenly increasing the voltage at the fault of the alternating current source 8.

In normal operating state of the eighth sample circuit, the thermistor 92 and the fuse 93 are in the conducting status. When the eighth sample circuit breaking down elevates current over the threshold, the fuse 93 burns. The resistance of the thermistor 92 increases due to temperature rising and forms a substantial open-loop. That can isolate damage to the AC-LED 7 induced by an overcurrent. Thus, the protection circuit of AC-LED 7 of light emitting module in accordance with the eighth embodiment can effectively protect the AC-LED 7 to avoid the damage of the AC-LED 7 by the fault of the eighth sample circuit.

In the eighth embodiment, the varistor 91 can be another circuit protection unit having voltage overload protecting characteristic. The fuse 93 and the thermistor 92 can be another circuit protection unit providing current overload protection.

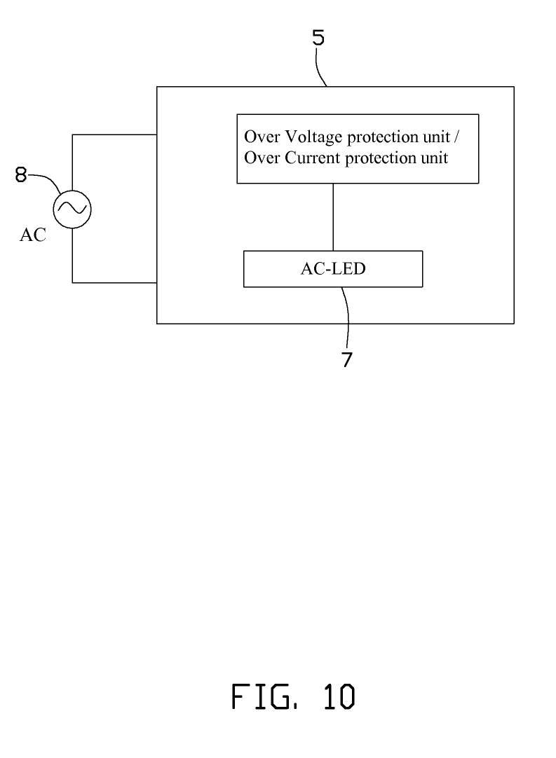

Referring to FIG. 10, the AC-LED 7, the voltage protection unit, and the current protection unit arranged in the illumination module 5 are driven by the alternating current source 8.

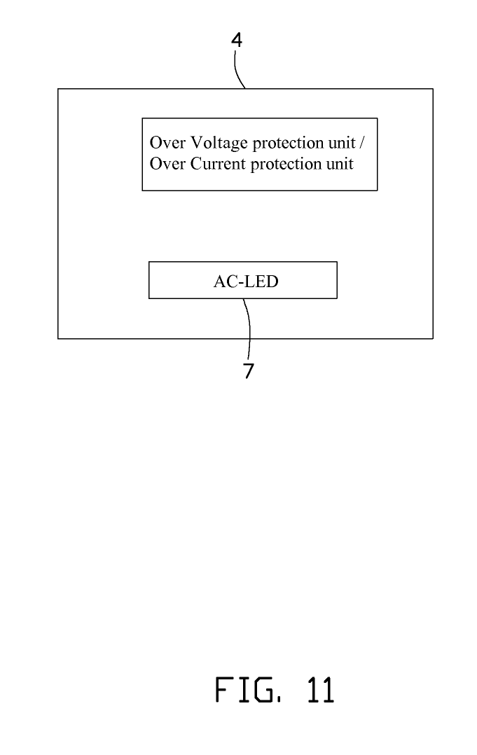

Referring to FIG. 11, the AC-LED 7, the voltage protection unit, and current protection unit are encapsulated into a LED chip by semiconductor process.

While certain embodiments have been described and exemplified, various others from the foregoing disclosure will be apparent to those skilled in the art. The disclosure is not limited to the particular embodiments described and exemplified but is capable of considerable variation and modification without departure from the scope of the appended claims.

What is claimed is:

1. An AC-LED protection circuit comprising:
an AC-LED consisting of a plurality of interconnected LEDs and comprising a first terminal and a second terminal electrically connecting with the LEDs, wherein when the first terminal is applied with a positive voltage and the second terminal is grounded at least one of the LEDs emits light, and when the second terminal is applied with the positive voltage and the second terminal is grounded at least another one of the LEDs emits light; and
a circuit protection unit comprising a first terminal and a second terminal, the first terminal of the circuit protection unit connecting to the first terminal of the AC-LED and the second terminal of the circuit protection unit connecting to the second terminal of the AC-LED;
wherein when a voltage difference between the first and second terminals of the circuit protection unit exceeds a threshold, the circuit protection unit substantially forms a short circuit; and
wherein when a current of the circuit protection unit exceeds a threshold, the circuit protection unit forms a substantial open circuit.

2. The AC-LED protection circuit of claim 1, wherein the circuit protection unit is a varistor.

3. The AC-LED protection circuit of claim 1, wherein the circuit protection unit is a thermistor.

4. The AC-LED protection circuit of claim 1, wherein the circuit protection unit is a fuse.

5. The AC-LED protection circuit of claim 1, wherein the circuit protection unit comprises a thermistor and a varistor.

6. The AC-LED protection circuit of claim 1, wherein the circuit protection unit comprises a fuse and a varistor.

7. The AC-LED protection circuit of claim 1, wherein the circuit protection unit comprises a fuse, a varistor and a thermistor.

8. An AC-LED protection circuit comprising: an AC-LED consisting of a plurality of interconnected LEDs and comprising a first terminal and a second terminal electrically connecting with the LEDs, wherein when the first terminal is applied with a positive voltage and the second terminal is grounded at least one of the LEDs emits light, and when the second terminal is applied with the positive voltage and the second terminal is grounded at least another one of the LEDs emits light; and
a voltage overload protection unit comprising a first terminal electrically connecting to the first terminal of the AC-LED and a second terminal electrically connecting to the second terminal of the AC-LED;
wherein when a voltage difference between the first and second terminals of the voltage overload protection unit exceeds a threshold, the voltage overload protection unit substantially forms a short circuit.

9. The AC-LED protection circuit of claim 8, wherein the voltage overload protection unit is a varistor.

10. An AC-LED protection circuit comprising: an AC-LED consisting of a plurality of interconnected LEDs and comprising a first terminal and a second terminal electrically connecting with the LEDs, wherein when the first terminal is applied with a positive voltage and the second terminal is grounded at least one of the LEDs emits light, and when the second terminal is applied with the positive voltage and the second terminal is grounded at least another one of the LEDs emits light; and
a current overload protection unit comprising a first terminal electrically connecting to the first terminal of the AC-LED and a second terminal electrically connecting to the second terminal of the AC-LED;
wherein when a current through the current overload protection unit exceeds a threshold, the current overload protection unit forms a substantial open circuit.

11. The AC-LED protection circuit of claim 10, wherein the current overload protection unit is a thermistor.

12. The AC-LED protection circuit of claim 10, wherein the current overload protection unit is a fuse.
